(19) United States
(12) Patent Application Publication
(10) Pub. No.: US 2014/0339442 A1
(43) Pub. Date: Nov. 20, 2014

(54) LIGHTING DEVICE OF CAMERA

(71) Applicant: INGRASYS TECHNOLOGY INC., Taoyuan (TW)

(72) Inventor: SHU-YUN HUANG, Taoyuan (TW)

(73) Assignee: INGRASYS TECHNOLOGY INC., Taoyuan (TW)

(21) Appl. No.: 14/050,370

(22) Filed: Oct. 10, 2013

(30) Foreign Application Priority Data
May 20, 2013 (TW) 102117773

(51) Int. Cl. F21V 3/02

(52) U.S. Cl. CPC F21V 3/02
USPC 250/495.1

(57) ABSTRACT

A lighting device of a camera includes a light board and a dome-shaped cover receiving the light board. The light board defines a first through hole in a center. A number of infrared lamps are slantingly mounted on a side of the light board and around the first through hole. The cover defines a second through hole aligning with the first through hole, and a number of lamp holes around the second through hole. The infrared lamps are extended through the lamp holes.

### BACKGROUND

1. Technical Field

The present disclosure relates to a lighting device of a camera.

2. Description of Related Art

Infrared lamps lighting for the lenses of cameras are often perpendicularly extended up from light boards of the cameras. As a result, the infrared lamps can illuminate only a small area, and the camera cannot take a wide angle image.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a lighting device of a camera.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

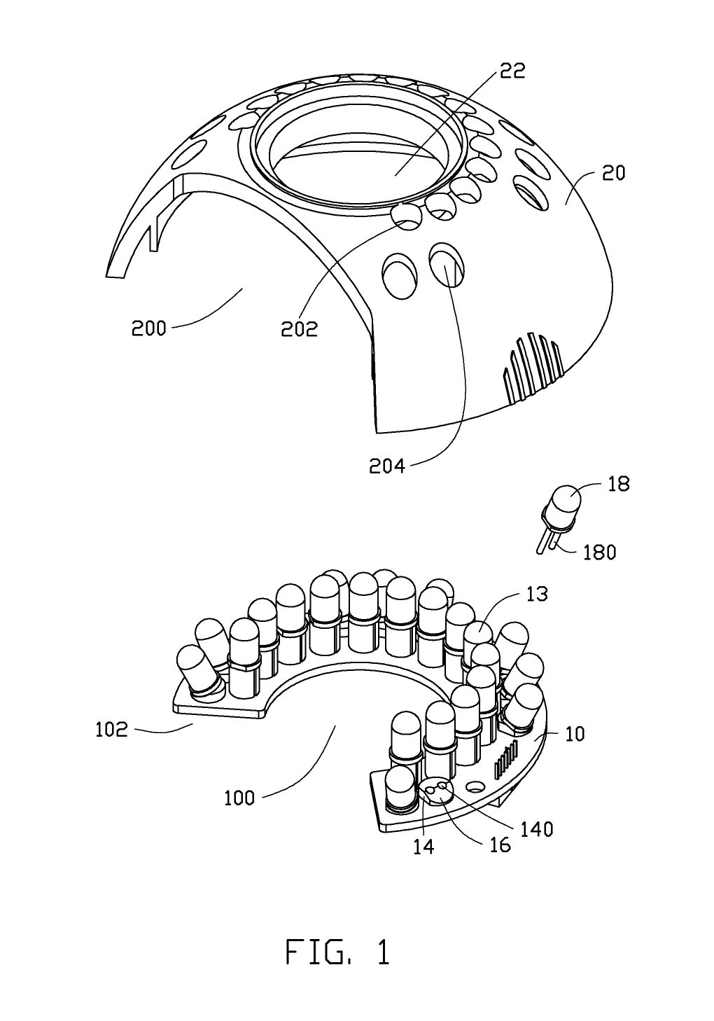

FIG. 1 shows an embodiment of a lighting device of a camera. The lighting device includes a round light board 10 and a dome-shaped cover 20 receiving the light board 10.

The light board 10 defines a first through hole 100 in a center, through which a lens cone (not shown) of the camera extends. The light board 10 defines an opening 102 communicating with the first through hole 100 and extending through a part of a circumference of the light board 10, the opening 102 facilitating a user to operate the lens cone. A plurality of infrared lamps 13 is perpendicularly mounted on a top side of the light board 10, around the first through hole 100. A plurality of bases 14 is mounted on the top side of the light board 10, around the first through hole 100, to fix a plurality of infrared lamps 18. Each infrared lamp 18 includes two pins 180 in a bottom. The infrared lamps 13 are positioned between the first through hole 100 and the infrared lamps 18.

A top surface 16 of each base 14 is a slanted surface slantingly extending away from the first through hole 100 and toward the light board 10. Each base 14 defines two fixing holes 140 in the top surface 16 to receive two pins 180 of one of the infrared lamps 18. Therefore, the bottom of each infrared lamp 18 contacts the corresponding top surface 16, to allow the infrared lamp 18 to slantingly extend up and away from the first through hole 100.

The dome cover 20 defines a second through hole 22 aligning with the first through hole 100 to allow the lens cone to extend through, a cutout 200 aligning with the opening 102, a plurality of receiving holes 202 corresponding to the infrared lamps 13, and a plurality of lamp holes 204 around the second through hole 22 and corresponding to the infrared lamps 18. The axis of each receiving hole 202 is parallel to the axis of the second through hole 22. The axis of each lamp hole 204 is unparallel to the axis of the second through hole 22.

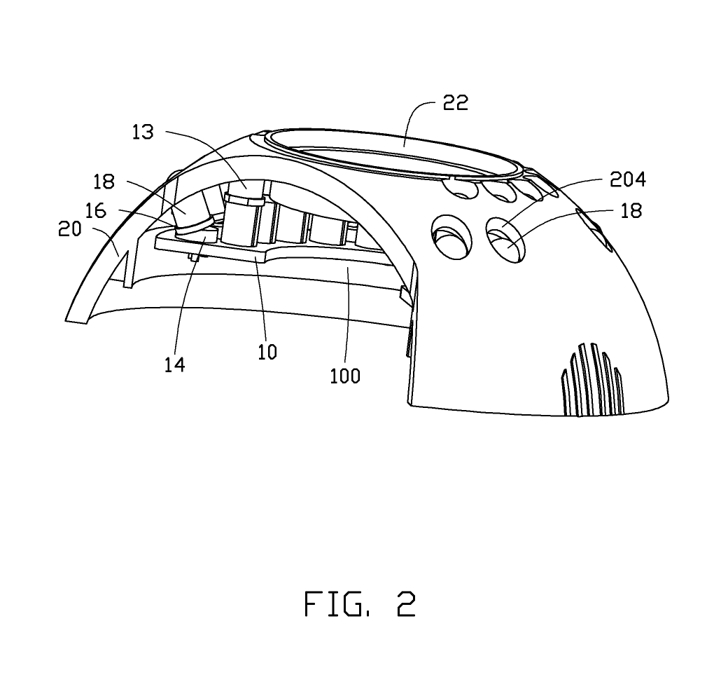

FIG. 2 shows that in assembly, the light board 10 is received in the cover 20, the infrared lamps 13 are extended through the receiving holes 202, and the infrared lamps 18 are slantingly extended through the lamp holes 24.

Because the infrared lamps 18 are slantingly extended through the lamp holes 24, the lighting device can illuminate a large area. Therefore, the camera can take a wide angle image.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A lighting device, comprising:
a light board defining a first through hole; wherein a plurality of first infrared lamps is mounted on a side of the light board and around the first through hole, the plurality of first infrared lamps is slantingly extend away from the first through hole; and
a dome-shaped cover defining a second through hole aligning with the first through hole and a plurality of lamp holes around the second through hole; wherein an axis of each lamp hole is unparallel to an axis of the second through hole;
wherein the light board is received in the cover, the plurality of first infrared lamps extends through the plurality of lamp holes.

2. The lighting device of claim 1, wherein a plurality of base protrudes on the side of the light board and around the first through hole, a top surface of each base is a slanted surface extending away from the first through hole and toward the light board, a bottom of each first infrared lamp contacts a corresponding one of the top surfaces.

3. The lighting device of claim 2, wherein each base defines two fixing holes in the top surface, each first infrared lamp comprises two pins extending from the bottom to be inserted into the fixing holes.

4. The lighting device of claim 1, wherein a plurality of second infrared lamps protrudes from the side of the light board and between the first through hole and the plurality of first infrared lamps, the cover defines a plurality of receiving holes between the second through hole and the plurality of lamp holes, to allow the plurality of second infrared lamps to extend through.

5. The lighting device of claim 4, wherein an axis of each receiving hole is parallel to the axis of the second through hole.

6. The lighting device of claim 1, wherein the light board defines an opening communicating with the first through hole and extending through a part of circumference of the light board.

7. The lighting device of claim 6, wherein the cover defines a cutout aligning with the opening.
